(19) United States
(12) Patent Application Publication
(10) Pub. No.: US 2010/0148896 A1
(43) Pub. Date: Jun. 17, 2010

(54) Magnetic Mounting System for Wet Environments

(76) Inventor: Richard Hugo, Bartlett, TN (US)

Correspondence Address: Kenneth E. Barnes, 80 Monroe Ave. Suite G-1, MEMPHIS, TN, 38103, US

(21) Appl. No.: 12/337,334

(22) Filed: Dec. 17, 2008

(51) Int. Cl. H01F 7/02

(52) U.S. Cl. 335/285

(57) ABSTRACT

A magnetic mounting system for wet environments suitable for use with magnetically attracted and non-magnetically attracted vertical surfaces, having a nonporous sealed compartment with a container support and a surface-contacting face, and enclosing a magnetically attracted material. The magnetically attracted material can be a ferrous metal plate used in combination with a hidden permanent magnet attached to the opposite side of a non-magnetically attracted vertical surface by a repositionable mounting means. The magnetically attracted material can also be a permanent magnet used with a magnetically attracted surface, or a permanent magnet used in combination with a repositionably mounted hidden ferrous metal plate or hidden permanent magnet depending upon the thickness of a non-magnetically attracted surface. The surface-contacting face may have vertical channels for draining away moisture, and the container support may be formed to be unitary with a container, or include a container attachment means. Other embodiments are disclosed.

### BACKGROUND OF THE INVENTION

This invention relates to means of mounting containers to vertical surfaces in wet environments, such as sinks or shower walls. In such locations, it is desirable to use a mounting means that does not penetrate the vertical surface, so as to limit the possibility of leaks. Several means for mounting containers in such locations are known in the prior art, such as suction cups, hooks, and adhesives. For example, a shower caddy that hooks over the exposed pipe of a shower head, or a sink caddy that hooks over the middle partition of a double sink, or containers adhered by means of suction cups or adhesives to a tile wall or to the inside of a sink are well known in the art.

The limitations of these various mounting means are also well known. Suction cups can get worn, lose resiliency, and may not stick, particularly if the surface is dirty or has a texture to it. Hooks are limited in the locations that they can be attached to because they must have a structure to hook onto. Adhesives can make it hard to remove and clean behind the mounted container, and the combination of moisture, surfactants, and microbiological attack can weaken the adhesive bond in these wet environments.

The surfaces commonly used in such environments are made from a number of different materials, including cast iron, stainless steels, porcelain or other ceramic materials, natural stone, and manmade materials including plastics or composites like fiberglass and engineered solid surfaces (e.g. Corian®).

A need exists for a mounting system for use in wet environments like sinks and showers which enables containers to be reliably mounted to the variety of types of surfaces used in such locations, without penetrating the surface, and which allows the container to be easily removed and replaced during cleaning.

It is an object of the present invention to provide a magnetic mounting system for use in wet environments that can be used to reliably mount containers to a variety of types of surfaces, including both magnetically and non-magnetically attracted surfaces, and surfaces having textures or other properties that make them unsuitable for use with prior art mounting means.

It is a further object of the present invention to provide a mounting system for use in wet environments that is resistant to corrosion, biofilm formation, and mechanical wear.

It is a further object of the present invention to provide a mounting system for use in wet environments that is not limited by the need to attach to any structure other than the vertical surface.

It is a further object of the present invention to provide a mounting system for use in wet environments that is easily removable and replaceable for cleaning.

### REFERENCE NUMBERS

100 Hidden permanent magnet
102 Means for mounting hidden permanent magnet
104 Hidden ferrous metal plate
106 Means for mounting hidden ferrous metal plate
108 Hook and loop fastener, (e.g. Velcro®)
110 Adhesive layer
112 Vertical surface
114 Container support
116 Nonporous sealed compartment
118 Surface-contacting face of nonporous sealed compartment
120 Vertical drainage channels
122 Magnetically attracted material
124 Permanent magnet
126 Ferrous metal plate
128 Container attachment means
130 Resilient deformable plug
132 Container
134 T-shaped slot
136 Wire basket
138 Stakes of wire basket

### BRIEF DESCRIPTION OF THE DRAWINGS

FIG. 1 is an exploded perspective view showing the magnetic mounting system with container support formed to be unitary with a container, according to an embodiment of the invention.

FIG. 2 is an exploded perspective view similar to FIG. 1 showing the magnetic mounting system and illustrating a hidden repositionable ferrous metal plate, according to another embodiment of the invention.

FIG. 3 is an exploded perspective view similar to FIG. 1 showing the magnetic mounting system and illustrating a hidden repositionable permanent magnet, according to another embodiment of the invention.

FIG. 4 is an assembled perspective view showing the magnetic mounting system of FIG. 3.

FIG. 5 is a transverse section view taken along the line IV-IV of FIG. 4.

FIG. 6A is an exploded perspective view showing the magnetic mounting system with container support having a mounting means for wire basket or other container, according to another embodiment of the invention.

FIG. 6B is an exploded perspective view depicting the nonporous sealed compartment of the embodiment shown in FIG. 6A as a unit, and illustrating an example of an alternative container.

FIG. 7A is a reverse angle exploded perspective view showing the magnetic mounting system similar to FIG. 6A and illustrating a hidden repositionable ferrous metal plate, according to another embodiment of the invention.

FIG. 7B is a partially assembled perspective view of the embodiment shown in FIG. 7A, and illustrating an example of an alternative container.

FIG. 8 is an exploded perspective view similar to FIG. 7A showing the magnetic mounting system and illustrating a hidden repositionable permanent magnet, according to another embodiment of the invention.

FIG. 9 is an assembled perspective view showing the magnetic mounting system of FIG. 8.

FIG. 10 is a longitudinal section view taken along the line IX-IX of FIG. 9.

### DETAILED DESCRIPTION OF THE PREFERRED EMBODIMENTS

The preferred embodiments of the invention are now described with reference to the accompanying drawings.

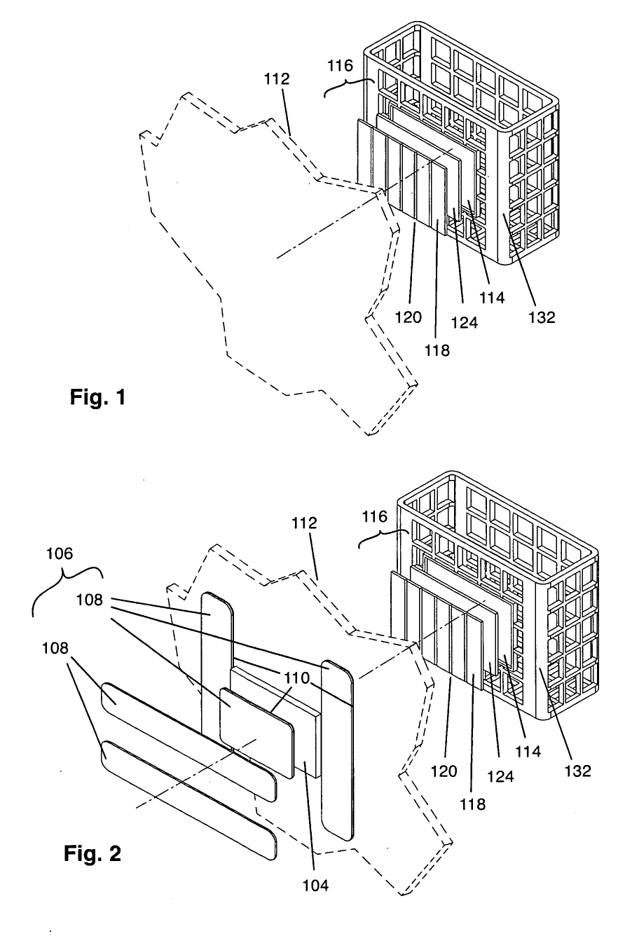

FIG. 1 is an exploded perspective view showing a magnetic mounting system according to the invention with a container support 114 formed to be unitary with a container 132. As shown, the container support 114 forms part of a nonporous sealed compartment 116 enclosing a permanent magnet 124. The nonporous sealed compartment 116 further comprises a surface-contacting face 118, which may have one or more vertical channels 120 for draining away moisture from the exterior of the nonporous sealed compartment 116, so as to inhibit formation of a microbial biofilm. In manufacture, the nonporous sealed compartment 116 enclosing the permanent magnet 124 can be formed to be unitary with the container 132 by injection molding of a suitable thermoplastic resin. The nonporous sealed compartment 116 is shown exploded here solely for clarity of illustration, but the container support 114 and surface-contacting face 118 may preferably be formed from the same molding operation as the container 132 rather than as separate pieces. Anti-microbial agents may also be added to the plastic during manufacture to further inhibit biofilm formation, as is well known in the art.

A permanent magnet 124 with a high Curie point (T_{C}), such as a samarium cobalt magnet, is preferred because the temperatures involved in the injection molding process can cause demagnetization of some other types of magnets. A samarium cobalt magnet is also preferred because of its high energy product relative to its size. The nonporous sealed compartment 116 serves to protect the magnet 124 from damage, and to prevent scratching of the surface 112 to which the surface-contacting face 118 is magnetically attracted that could result from contact with an exposed magnet. The thickness of the surface-contacting face 118 is limited by the need to provide for drainage channels 120 while maintaining structural integrity of the nonporous sealed compartment 116 and maximizing magnetic adhesion. This embodiment is suitable for use with a magnetically attracted vertical surface 112, which could be a ferrous metal like cast iron.

FIG. 2 is an exploded perspective view similar to FIG. 1 illustrating another embodiment of a magnetic mounting system according to the invention. A ferrous metal plate 104 is mounted to a vertical surface 112, by a repositionable mounting means 106, which is preferably one or more hook-and-loop fasteners 108. Patches of one layer of the hook-and-loop fastener 108 are attached by adhesive layers 110 to the back of the ferrous metal plate 104, as well as to the vertical surface 112 alongside where the ferrous metal plate 104 is to be mounted. Sections of the complementary layer of the hook-and-loop fastener 108 are then used to strap the ferrous metal plate 104 tightly to the vertical surface 112, in cooperation with the patches attached to the vertical surface 112 and the ferrous metal plate 104.

A nonporous sealed compartment 116, comprising a container support 114 and surface-contacting face 118, and enclosing a permanent magnet 124 is formed to be unitary with a container 132. The permanent magnet 124 is attracted to the ferrous metal plate 104 through the vertical surface 112 and the surface-contacting face 1 18 is thereby adhered to the vertical surface 112 by magnetic attraction. A permanent magnet 124 with a high Curie point (T_{C}), such as a samarium cobalt magnet, is preferred because the temperatures involved in the injection molding process can cause demagnetization of some other types of magnets. A samarium cobalt magnet is also preferred because of its high energy product relative to its size.

The surface-contacting face 118 may have one or more vertical channels 120 for draining away moisture from the exterior of the nonporous sealed compartment 116, so as to inhibit formation of a microbial biofilm. In manufacture, the nonporous sealed compartment 116 enclosing the permanent magnet 124 can be formed to be unitary with the container 132 by injection molding of a suitable thermoplastic resin. Anti-microbial agents may be added to the plastic during manufacture to further inhibit biofilm formation, as is well known in the art.

The nonporous sealed compartment 116 serves to protect the magnet 124 from damage, and to prevent scratching of the surface 112 to which the surface-contacting face 1 18 is magnetically attracted that could result from contact with an exposed magnet. The thickness of the surface-contacting face 1 18 is limited by the need to provide for drainage channels 120 while maintaining structural integrity of the nonporous sealed compartment 116 and maximizing magnetic adhesion.

Use of a repositionable mounting means 106 to mount the ferrous metal plate 104 to the vertical surface 112 facilitates alignment of the ferrous metal plate 104 and the permanent magnet 124, such that the container 132 is oriented vertically.

This embodiment is suitable for use with thin surfaces that are not magnetically attracted (such as austenitic stainless steels or ceramic tile). Use of a ferrous metal plate, rather than a second magnet as described below, reduces the cost of manufacture in such applications.

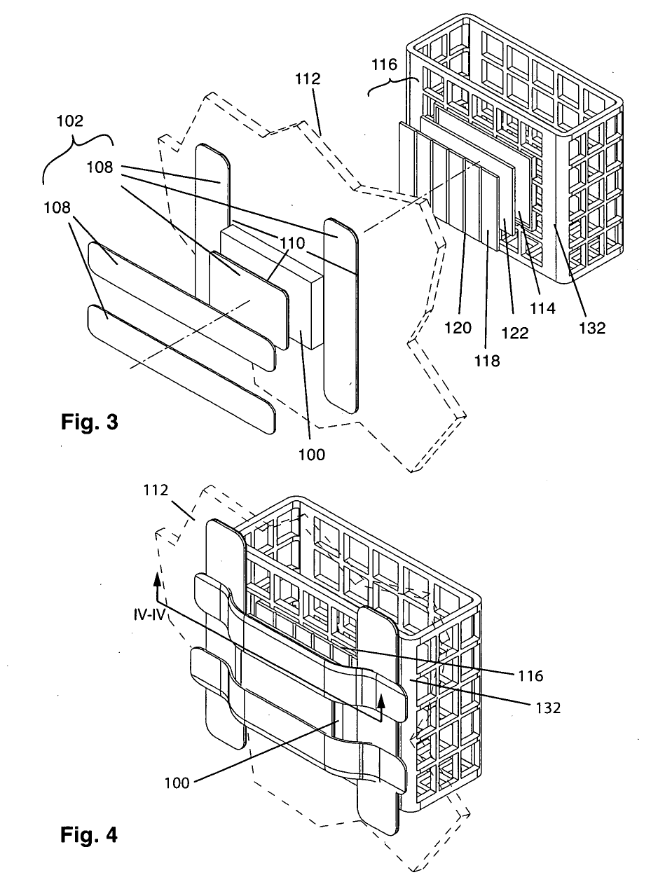

FIG. 3 is an exploded perspective view similar to FIG. 1 illustrating another embodiment of a magnetic mounting system according to the invention. A permanent magnet 100 is mounted to a vertical surface 112, such as the side of a sink, by a repositionable mounting means 102, which is preferably one or more hook-and-loop fasteners 108. Patches of one layer of the hook-and-loop fastener 108 are attached by adhesive layers 110 to the back of the magnet 100, as well as to the vertical surface 112 alongside where the magnet 100 is to be mounted. Sections of the complementary layer of the hook-and-loop fastener 108 are then used to strap the magnet 100 tightly to the vertical surface 112, in cooperation with the patches attached to the vertical surface 112 and the magnet 100.

The permanent magnet 100 may also mounted to the vertical surface 112 of a shower enclosure. Due to inaccessibility of the location for mounting the permanent magnet 100 under such circumstances, the permanent magnet 100 would preferably need to be mounted behind the wall of the shower enclosure during construction of the shower, or molded into the wall of the shower enclosure during manufacture.

A container support 114 forms part of a nonporous sealed compartment 116 that is formed to be unitary with a container 132. The nonporous sealed compartment 116 further comprises a surface-contacting face 118, which may have one or more vertical channels 120 for draining away moisture from the exterior of the nonporous sealed compartment 116, so as to inhibit formation of a microbial biofilm. A magnetically attracted material 122, such as a ferrous metal plate, or a permanent magnet whose polarity is configured to be opposite to the polarity of the permanent magnet 100 mounted to the vertical surface 112 is enclosed in the nonporous sealed compartment 116. The magnetically attracted material 122 is attracted to the permanent magnet 100 through the vertical surface 112 and the surface-contacting face 118 is thereby adhered to the vertical surface 112 by magnetic attraction.

In manufacture, the nonporous sealed compartment 116 enclosing the magnetically attracted material 122 can be formed to be unitary with the container 132 by injection molding of a suitable thermoplastic resin. The nonporous sealed compartment 116 is shown exploded here solely for clarity of illustration, but the container support 114 and surface-contacting face 118 may preferably be formed from the same molding operation as the container 132 rather than as separate pieces. Anti-microbial agents may be added to the plastic during manufacture to further inhibit biofilm formation, as is well known in the art. The thickness of the surface-contacting face 118 is limited by the need to provide for drainage channels 120 while maintaining structural integrity of the nonporous sealed compartment 116 and maximizing magnetic adhesion.

Because it is hidden on the opposite side of the vertical surface 112, the permanent magnet 100 attached to the vertical surface 112 may be a larger, cheaper magnet than might otherwise be practical or desirable for aesthetic reasons if used to mount a container directly. In a preferred embodiment, a ceramic magnet is used. The visible portion of the magnetic mounting system may thus be more aesthetically pleasing, and more effectively adhered to the surface than might otherwise be possible relying solely on a magnet attached to the container itself. Use of a hidden permanent magnet also enables the magnetic mounting system to be used with surfaces that are not magnetically attracted, such as ceramic tile, engineered solid surfaces (e.g. Corian®), and certain types of stainless steel.

Use of a ferrous metal plate as the magnetically attracted material 122 is preferred for use with thin surfaces that are not magnetically attracted (such as austenitic stainless steels or ceramic tile). Use of a ferrous metal plate rather than a second magnet reduces the cost of manufacture in such applications. The nonporous sealed compartment 116 enclosing the ferrous metal plate serves to protect the metal from moisture and corrosion, and to prevent scratching of the surface 112 to which the surface-contacting face 118 is magnetically attracted that could result from direct contact with an exposed metal plate. The ferrous metal plate may also be galvanized for additional protection against corrosion, as is well known.

Use of a permanent magnet as the magnetically attracted material 122 is preferred for use with thick surfaces that are not magnetically attracted (e.g. Corian®), because a two magnet system strengthens and extends the magnetic field across a greater distance. If a permanent magnet is used as the magnetically attracted material 122, a magnet with a high Curie point (T_{C}), such as a samarium cobalt magnet, is preferred because the temperatures involved in the injection molding process can cause demagnetization of some other types of magnets. A samarium cobalt magnet is also preferred because of its high energy product relative to its size. The nonporous sealed compartment 116 serves to protect the magnet 124 from damage, and to prevent scratching of the surface 112 to which the surface-contacting face 118 is magnetically attracted that could result from contact with an exposed magnet.

Use of a repositionable mounting means 102 to mount the hidden permanent magnet 100 to the vertical surface 112 enables adjustment of the interaction between the magnetically attracted material 122 and the permanent magnet 100, such that the container 132 is oriented vertically. This adjustability is most desirable where the magnetically attracted material 122 is a permanent magnet.

FIG. 4 illustrates the magnetic mounting system of FIG. 3 in its assembled state, where the nonporous sealed compartment 116 and its unitary container 132 is adhered to the vertical surface 112 by magnetic attraction through the vertical surface 112 to the hidden repositionable permanent magnet 100 mounted to the opposite side of the vertical surface 112.

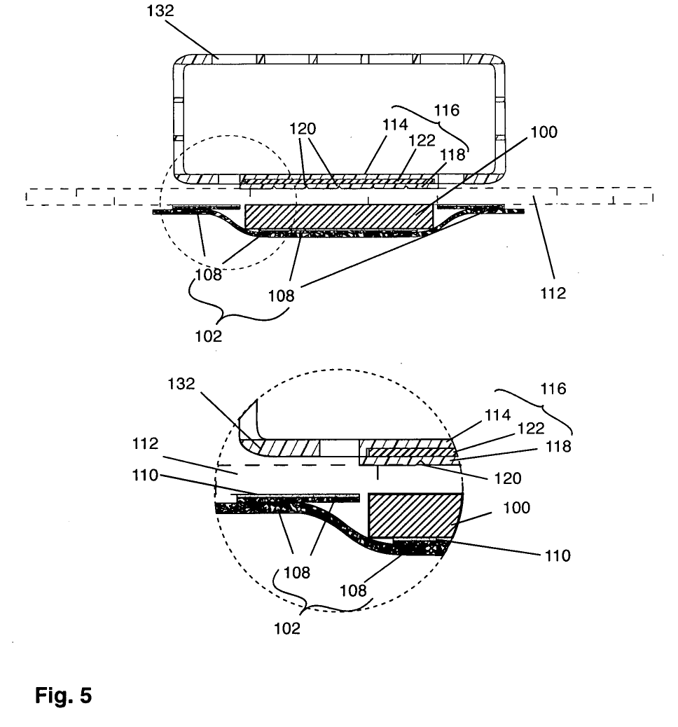

FIG. 5 is a transverse section view taken along the line IV-IV of FIG. 4, depicting the hidden repositionable permanent magnet 100 mounted to a vertical surface 112, by a repositionable mounting means 102, which is preferably one or more hook-and-loop fasteners 108. Patches of one layer of the hook-and-loop fastener are attached to the magnet 100 and the vertical surface 112 by adhesive layers 110 (see detail view). Sections of the complementary layer of the hook-and-loop fastener 108 are then used to strap the magnet 100 tightly to the vertical surface 112, in cooperation with the patches attached to the vertical surface 112 and the magnet 100. A nonporous sealed compartment 116 comprising a container support 114 and a surface-contacting face 118 encloses a magnetically attracted material 122 attracted to the permanent magnet 100 through the vertical surface 112, and the surface-contacting face 118 is thereby adhered to the vertical surface 112 by magnetic attraction. The nonporous sealed compartment 116 may be formed to be unitary with a container 132. The magnetically attracted material 122 enclosed within the nonporous sealed compartment 116 can be a ferrous metal plate, or a permanent magnet whose polarity is configured to be opposite to the polarity of the permanent magnet 100 mounted to the vertical surface 112. The surface-contacting face 118 of the nonporous sealed compartment 116 may have one or more vertical channels 120 (see detail view) for draining away moisture from the exterior of the nonporous sealed compartment 116, so as to inhibit formation of a microbial biofilm.

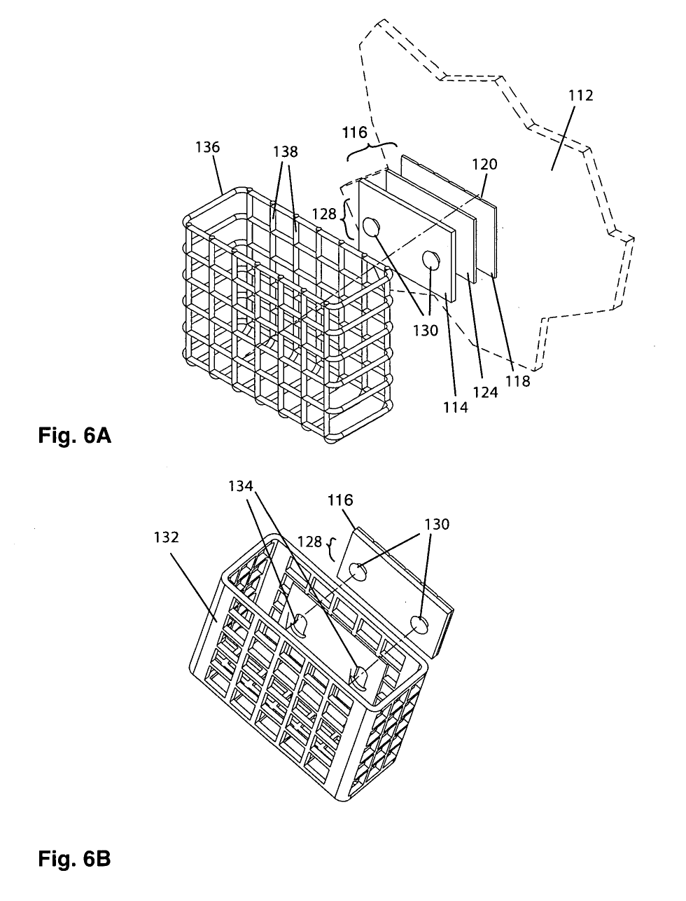

FIG. 6A is an exploded perspective view showing a magnetic mounting system according to another embodiment of the invention, with a container support 114 having a container attachment means 128 for attaching a wire basket 136 or other container. As shown, the container support 114 forms part of a nonporous sealed compartment 116 enclosing a permanent magnet 124. The nonporous sealed compartment 116 further comprises a surface-contacting face 118, which may have one or more vertical channels 120 for draining away moisture from the exterior of the nonporous sealed compartment 116, so as to inhibit formation of a microbial biofilm. In manufacture, the nonporous sealed compartment 116 enclosing the permanent magnet 124 can be formed by injection molding of a suitable thermoplastic resin. The nonporous sealed compartment 116 is shown exploded here solely for clarity of illustration, but the container support 114 and surface-contacting face 118 may preferably be formed from the same molding operation rather than as separate pieces. Anti-microbial agents may also be added to the plastic during manufacture to further inhibit biofilm formation, as is well known in the art. The thickness of the surface-contacting face 118 is limited by the need to provide for drainage channels 120 while maintaining structural integrity of the nonporous sealed compartment 116 and maximizing magnetic adhesion.

A permanent magnet 124 with a high Curie point (T_{C}), such as a samarium cobalt magnet, is preferred because the temperatures involved in the injection molding process can cause demagnetization of some other types of magnets. A samarium cobalt magnet is also preferred because of its high energy product relative to its size. The nonporous sealed compartment 116 serves to protect the magnet 124 from damage, and to prevent scratching of the surface 112 to which the surface contacting face 118 is magnetically attracted that could result from contact with an exposed magnet.

FIG. 6B is an exploded perspective view depicting the nonporous sealed compartment 116 of this embodiment formed as a unit, and illustrating an example of an alternative container 132. The container attachment means 128 can be one or more resilient deformable plugs 130 configured to fit between the stakes 138 of a wire basket 136 (as shown in FIG. 6A), or into t-shaped slots 134 in another container 132. The resilient deformable plug 130 may be made of any suitable elastomeric material, such as silicone rubber or other resilient deformable plastic, and may be molded into the container support 114 during the injection molding process. Use of a resilient deformable plug is preferred because unlike bolts or screws, it will not corrode in a wet environment, and permits a variety of containers to be mounted without the use of tools. The embodiment shown in FIGS. 6A and 6B is suitable for use with a magnetically attracted vertical surface 112, which could be a ferrous metal like cast iron.

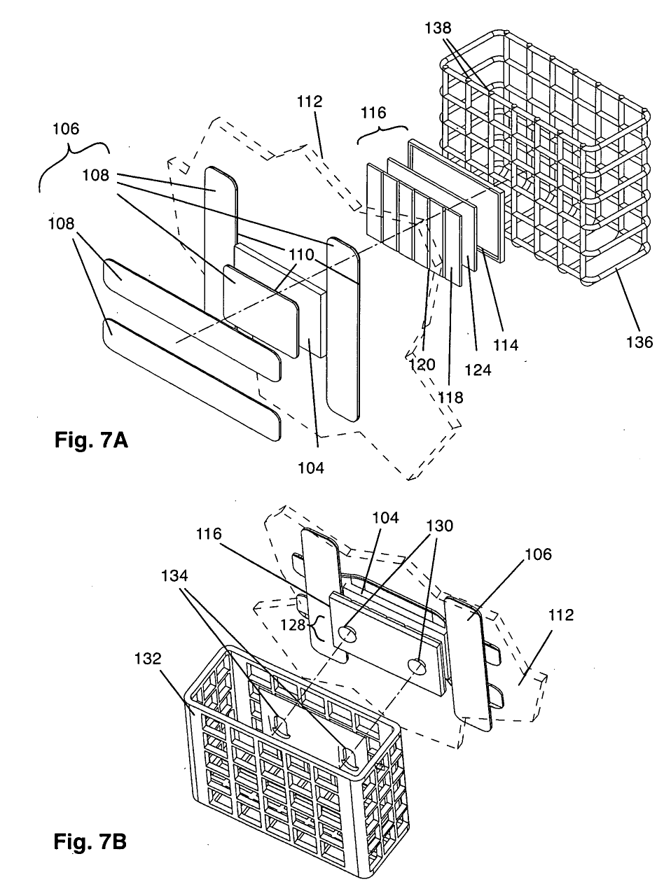

FIG. 7A is an exploded perspective view depicting another embodiment of a magnetic mounting system according to the invention. A ferrous metal plate 104 is mounted to a vertical surface 112, such as the side of a sink, by a repositionable mounting means 106, which is preferably one or more hook-and-loop fasteners 108. Patches of one layer of the hook-and-loop fastener 108 are attached by adhesive layers 110 to the back of the ferrous metal plate 104, as well as to the vertical surface 112 alongside where the ferrous metal plate 104 is to be mounted. Sections of the complementary layer of the hook-and-loop fastener 108 are then used to strap the ferrous metal plate 104 tightly to the vertical surface 112, in cooperation with the patches attached to the vertical surface 112 and the ferrous metal plate 104.

The ferrous metal plate 104 may also mounted to the vertical surface 112 of a shower enclosure. Due to inaccessibility of the location for mounting the hidden ferrous metal plate 104 under such circumstances, the hidden ferrous metal plate 104 would preferably need to be mounted behind the wall of the shower enclosure during construction of the shower, or molded into the wall of the shower enclosure during manufacture.

A nonporous sealed compartment 1 16 enclosing a permanent magnet 124, further comprises a surface-contacting face 118, a container support 114, and a container attachment means (see FIG. 7B for one example) for attaching a wire basket 136 or other container. The permanent magnet 124 is attracted to the ferrous metal plate 104 through the vertical surface 112 and the surface-contacting face 118 is thereby adhered to the vertical surface 112 by magnetic attraction. A magnet 124 with a high Curie point (T_{C}), such as a samarium cobalt magnet, is preferred because the temperatures involved in the injection molding process can cause demagnetization of some other types of magnets. A samarium cobalt magnet is also preferred because of its high energy product relative to its size.

The surface-contacting face 118 may have one or more vertical channels 120 for draining away moisture from the exterior of the nonporous sealed compartment 116, so as to inhibit formation of a microbial biofilm. In manufacture, the nonporous sealed compartment 116 enclosing the permanent magnet 124 can be formed by injection molding of a suitable thermoplastic resin. The nonporous sealed compartment 116 is shown exploded here solely for clarity of illustration, but the container support 114 and surface-contacting face 118 may preferably be formed from the same molding operation rather than as separate pieces. Anti-microbial agents may be added to the plastic during manufacture to further inhibit biofilm formation, as is well known in the art.

The nonporous sealed compartment 116 serves to protect the permanent magnet 124 from damage, and to prevent scratching of the surface 112 to which the surface-contacting face 118 is magnetically attracted that could result from contact with an exposed magnet. The thickness of the surface-contacting face 118 is limited by the need to provide for drainage channels 120 while maintaining structural integrity of the nonporous sealed compartment 116 and maximizing magnetic adhesion.

Use of a repositionable mounting means 106 to mount the ferrous metal plate 104 to the vertical surface 112 enables alignment of the ferrous metal plate 104 and the permanent magnet 124, such that the wire basket 136 is oriented vertically.

FIG. 7B is a partially assembled perspective view depicting the nonporous sealed compartment 116 of the embodiment shown in FIG. 7A formed as a unit, the assembled configuration of the repositionable mounting means 106 attaching the ferrous metal plate 104 to the vertical surface 112, and illustrating an example of an alternative container 132. The container attachment means 128 can be one or more resilient deformable plugs 130 configured to fit between the stakes 138 of a wire basket 136 (shown in FIG. 7A), or into t-shaped slots 134 in another container 132. The resilient deformable plug may be made of any suitable elastomeric material, such as silicone rubber or other resilient deformable plastic, and may be molded into the container support 114 during the injection molding process. Use of a resilient deformable plug is preferred because unlike bolts or screws, it will not corrode in a wet environment, and permits a variety of containers to be mounted without the use of tools.

The embodiment shown in FIGS. 7A and 7B is suitable for use with thin surfaces that are not magnetically attracted (such as austenitic stainless steels or ceramic tile). Use of a ferrous metal plate, rather than a second magnet as described below, reduces the cost of manufacture in such applications.

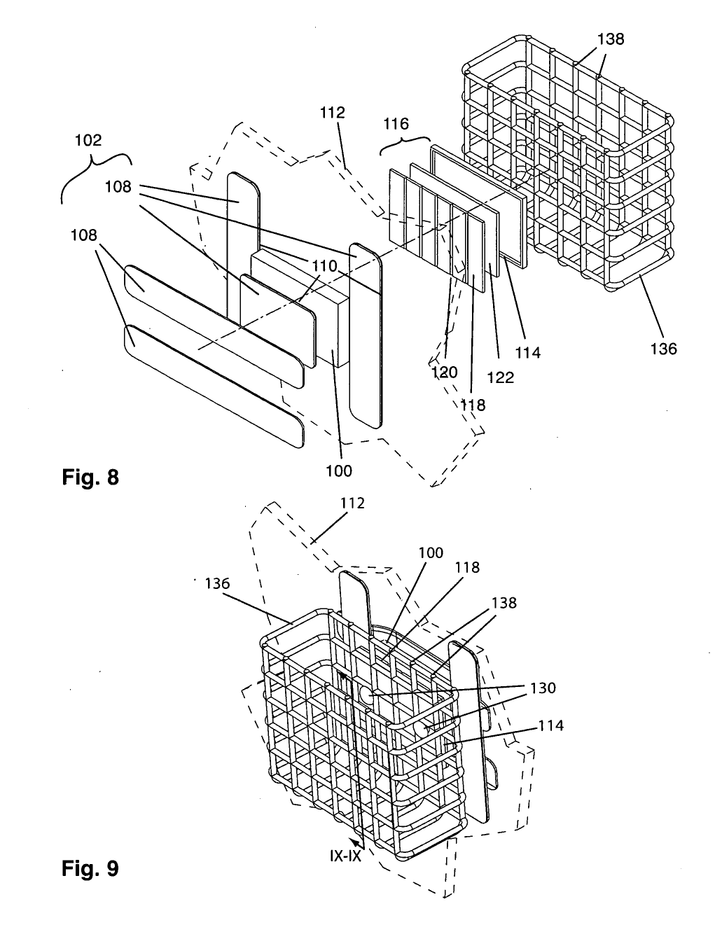

FIG. 8 is an exploded perspective view similar to FIG. 7 illustrating another embodiment of the magnetic mounting system according to the invention. A permanent magnet 100 is mounted to a vertical surface 112, such as the side of a sink, by a repositionable mounting means 102, which is preferably one or more hook-and-loop fasteners 108. Patches of one layer of the hook-and-loop fastener 108 are attached by adhesive layers 110 to the back of the magnet 100, as well as to the vertical surface 112 alongside where the magnet 100 is to be mounted. Sections of the complementary layer of the hook-and-loop fastener 108 are then used to strap the magnet 100 tightly to the vertical surface 112, in cooperation with the patches attached to the vertical surface 112 and the magnet 100.

A nonporous sealed compartment 116 enclosing a magnetically attracted material 122, further comprises a surface-contacting face 118, a container support 114, and a container attachment means (not visible, see FIG. 7B for one example) for attaching a wire basket 136 or other container. The magnetically attracted material 122 may be a ferrous metal plate, or a permanent magnet whose polarity is configured to be opposite to the polarity of the permanent magnet 100 mounted to the vertical surface 112. The magnetically attracted material 122 is attracted to the permanent magnet 100 through the vertical surface 112 and the surface-contacting face 118 is thereby adhered to the vertical surface 112 by magnetic attraction.

The surface-contacting face 118 may have one or more vertical channels 120 for draining away moisture from the exterior of the nonporous sealed compartment 116, so as to inhibit formation of a microbial biofilm. In manufacture, the nonporous sealed compartment 116 enclosing the magnetically attracted material 122 can be formed by injection molding of a suitable thermoplastic resin. The nonporous sealed compartment 116 is shown exploded here solely for clarity of illustration, but the container support 114 and surface-contacting face 118 may preferably be formed from the same molding operation rather than as separate pieces. Anti-microbial agents may be added to the plastic during manufacture to further inhibit biofilm formation, as is well known in the art. The nonporous sealed compartment 116 serves to protect the magnet 124 from damage, and to prevent scratching of the surface 112 to which the surface-contacting face 118 is magnetically attracted that could result from contact with an exposed magnet. The thickness of the surface-contacting face 118 is limited by the need to provide for drainage channels 120 while maintaining structural integrity of the nonporous sealed compartment 116 and maximizing magnetic adhesion.

Because it is hidden, the permanent magnet 100 attached to the vertical surface 112 m ay be a larger, cheaper magnet than might otherwise be practical or desirable for aesthetic reasons if used to mount a container directly. In a preferred embodiment, a ceramic magnet is used. The visible portion of the magnetic mounting system may thus be more aesthetically pleasing, and more effectively adhered to the surface than might otherwise be possible relying solely on a magnet attached to the container itself. Use of a hidden permanent magnet also enables the magnetic mounting system to be used with surfaces that are not magnetically attracted, such as ceramic tile, engineered solid surfaces (e.g. Corian®), and certain types of stainless steel.

The permanent magnet 100 may also mounted to the vertical surface 112 of a shower enclosure. Due to inaccessibility of the location for mounting the hidden permanent magnet 100 under such circumstances, the hidden permanent magnet 100 would preferably need to be mounted behind the wall of the shower enclosure during construction of the shower, or molded into the wall of the shower enclosure during manufacture.

Use of a ferrous metal plate as the magnetically attracted material 122 is preferred for use with thin surfaces that are not magnetically attracted (such as austenitic stainless steels or ceramic tile). Use of a ferrous metal plate rather than a second magnet reduces the cost of manufacture in such applications. The nonporous sealed compartment 116 enclosing the ferrous metal plate serves to protect the metal from moisture and corrosion, and to prevent scratching of the surface 112 to which the surface-contacting face 118 is magnetically attracted that could result from direct contact with an exposed metal plate. The ferrous metal plate may also be galvanized for additional protection against corrosion, as is well known.

Use of a permanent magnet as the magnetically attracted material 122 is preferred for use with thick surfaces that are not magnetically attracted (e.g. Corian®), because a two magnet system strengthens and extends the magnetic field across a greater distance. If a permanent magnet is used as the magnetically attracted material 122, a magnet with a high Curie point (T_{C}), such as a samarium cobalt magnet, is preferred because the temperatures involved in the injection molding process can cause demagnetization of some other types of magnets. A samarium cobalt magnet is also preferred because of its high energy product relative to its size. The nonporous sealed compartment 116 serves to protect the magnet 124 from damage, and to prevent scratching of the surface 112 to which the surface-contacting face 118 is magnetically attracted that could result from contact with an exposed magnet.

Use of a repositionable mounting means 102 to mount the hidden permanent magnet 100 to the vertical surface 112 enables adjustment of the interaction between the magnetically attracted material 122 and the permanent magnet 100, such that the wire basket 136 is oriented vertically. This adjustability is most desirable where the magnetically attracted material 122 is a permanent magnet.

The container attachment means (not visible, see FIG. 7B for one example) can be one or more resilient deformable plugs 130 configured to fit between the stakes 138 of a wire basket 136, or into t-shaped slots 134 in another container 132. The resilient deformable plugs 130 may be made of any suitable elastomeric material, such as silicone rubber or other resilient deformable plastic, and may be molded into the container support 114 during the injection molding process. Use of a resilient deformable plug is preferred because unlike bolts or screws, it will not corrode in a wet environment, and permits a variety of containers to be mounted without the use of tools.

FIG. 9 is a reverse angle perspective view illustrating the embodiment of the invention shown in FIG. 8 in its assembled state, where the surface contacting face 118 is adhered to the vertical surface 112 by magnetic attraction through the vertical surface 112 to the hidden repositionable permanent magnet 100 mounted to the opposite side of the vertical surface 112, and a wire basket 136 is attached to the container support 114 by resilient deformable plugs 130 inserted between the stakes 138 of the wire basket 136. The wire basket 136 may be plastic coated, as is well known, to prevent corrosion in a wet environment.

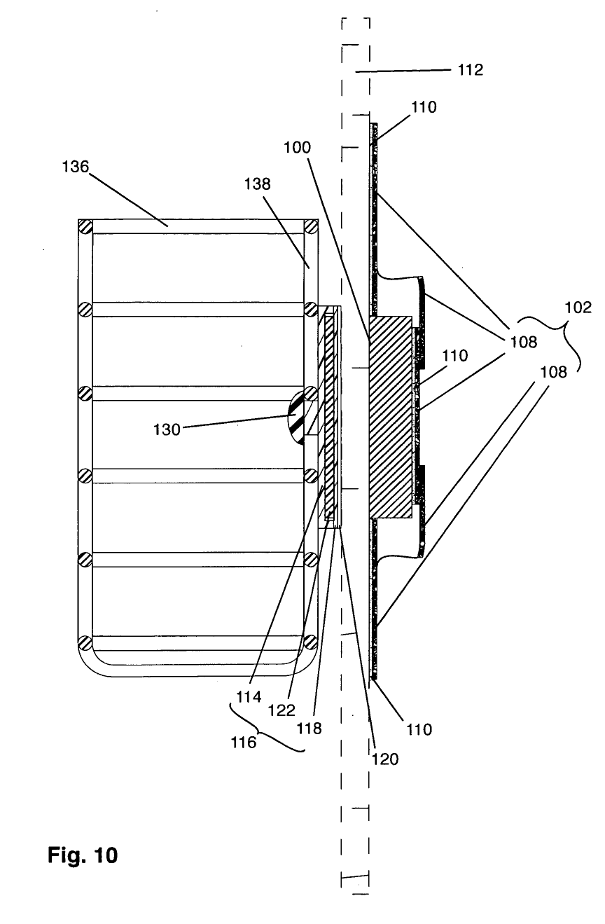

FIG. 10 is a longitudinal section view taken along the line IX-IX of FIG. 9, depicting the hidden repositionable permanent magnet 100 mounted to a vertical surface 112, by a repositionable mounting means 102, which is preferably one or more hook-and-loop fasteners 108. Patches of one layer of the hook-and-loop fastener 108 are attached by adhesive layers 110 to the back of the magnet 100, as well as to the vertical surface 112 alongside where the magnet 100 is to be mounted. Sections of the complementary layer of the hook-and-loop fastener 108 are then used to strap the magnet 100 tightly to the vertical surface 112, in cooperation with the patches attached to the vertical surface 112 and the magnet 100. A nonporous sealed compartment 116 comprising a container support 114 and a surface contacting face 118 encloses a magnetically attracted material 122 attracted to the permanent magnet 100 through the vertical surface 112, and the surface-contacting face 118 is thereby adhered to the vertical surface 112 by magnetic attraction. The magnetically attracted material 122 enclosed within the nonporous sealed compartment 116 can be a ferrous metal plate, or a permanent magnet whose polarity is configured to be opposite to the polarity of the permanent magnet 100 mounted to the vertical surface 112. The surface contacting face 118 of the nonporous sealed compartment 116 may have one or more vertical channels 120 for draining away moisture from the exterior of the nonporous sealed compartment 116, so as to inhibit formation of a microbial biofilm. Resilient deformable plugs 130 molded into the nonporous sealed compartment 116 are configured to fit between the stakes 138 of a wire basket 136 and provide a container attachment means connecting the container support 114 to the wire basket 132.

Although the invention has been shown and described with reference to certain specific presently preferred embodiments, the given embodiments should not be construed as limitations on the scope of the invention, but as illustrative examples, and those skilled in the art to which this invention pertains will undoubtedly find alternative embodiments obvious after reading this disclosure.

I claim:

1. A magnetic mounting system for wet environments, comprising:
(a) a permanent magnet;
(b) a means for mounting said permanent magnet to a vertical surface;
(c) a nonporous sealed compartment enclosing a material attracted to said permanent magnet through the vertical surface and thereby adhered to the vertical surface by magnetic attraction; said nonporous sealed compartment comprising
(d) a container support; and
(e) a face for contacting the vertical surface.

2. The magnetic mounting system of claim 1, wherein the means for mounting the permanent magnet to a vertical surface is repositionable.

3. The magnetic mounting system of claim 1, wherein the material attracted to the permanent magnet through the vertical surface comprises at least one ferrous metal plate.

4. The magnetic mounting system of claim 1, wherein the material attracted to the permanent magnet through the vertical surface comprises one or more permanent magnets whose polarity is configured to be opposite to the polarity of the permanent magnet mounted to the vertical surface.

5. The magnetic mounting system of claim 1, wherein the face for contacting the vertical surface further comprises one or more vertical channels for draining away moisture from the exterior of the nonporous sealed compartment.

6. The magnetic mounting system of claim 1, wherein the container support is formed to be unitary with a container.

7. The magnetic mounting system of claim 1, wherein the container support comprises a container attachment means.

8. The magnetic mounting system of claim 2, wherein the means for mounting the permanent magnet to a vertical surface comprises one or more hook-and-loop fasteners configured to strap the permanent magnet to the vertical surface.

9. The magnetic mounting system of claim 8, wherein the container support is formed to be unitary with a container.

10. The magnetic mounting system of claim 8, wherein the container support comprises a container attachment means.

11. The magnetic mounting system of claim 9, wherein the material attracted to the permanent magnet through the vertical surface comprises at least one ferrous metal plate.

12. The magnetic mounting system of claim 9, wherein the material attracted to the permanent magnet through the vertical surface comprises one or more permanent magnets whose polarity is configured to be opposite to the polarity of the permanent magnet mounted to the vertical surface.

13. The magnetic mounting system of claim 11, wherein the face for contacting the vertical surface further comprises one or more vertical channels for draining away moisture from the exterior of the nonporous sealed compartment.

14. The magnetic mounting system of claim 12, wherein the face for contacting the vertical surface further comprises one or more vertical channels for draining away moisture from the exterior of the nonporous sealed compartment.

15. The magnetic mounting system of claim 10, wherein the container attachment means comprises one or more resilient deformable plugs configured to fit into openings in a container.

16. The magnetic mounting system of claim 15, wherein the material attracted to the permanent magnet through the vertical surface comprises at least one ferrous metal plate.

17. The magnetic mounting system of claim 15, wherein the material attracted to the permanent magnet through the vertical surface comprises one or more permanent magnets whose polarity is configured to be opposite to the polarity of the permanent magnet mounted to the vertical surface.

18. The magnetic mounting system of claim 16, wherein the face for contacting the vertical surface further comprises one or more vertical channels for draining away moisture from the exterior of the nonporous sealed compartment.

19. The magnetic mounting system of claim 17, wherein the face for contacting the vertical surface further comprises one or more vertical channels for draining away moisture from the exterior of the nonporous sealed compartment.

20. A magnetic mounting system for wet environments, comprising:
(a) a ferrous metal plate;
(b) a means for mounting said ferrous metal plate to a vertical surface;
(c) a nonporous sealed compartment enclosing a permanent magnet attracted to said ferrous metal plate through the vertical surface and thereby adhered to the vertical surface by magnetic attraction; said nonporous sealed compartment comprising
(d) a container support; and
(e) a face for contacting the vertical surface.

21. The magnetic mounting system of claim 20, wherein the means for mounting the ferrous metal plate to a vertical surface is repositionable.

22. The magnetic mounting system of claim 20 wherein the face for contacting the vertical surface further comprises one or more vertical channels for draining away moisture from the exterior of the nonporous sealed compartment.

23. The magnetic mounting system of claim 20, wherein the container support is formed to be unitary with a container.

24. The magnetic mounting system of claim 20, wherein the container support further comprises a container attachment means.

25. The magnetic mounting system of claim 21, wherein the means for mounting the ferrous metal plate to a vertical surface comprises one or more hook-and-loop fasteners configured to strap the ferrous metal plate to the vertical surface.

26. The magnetic mounting system of claim 25, wherein the container support is formed to be unitary with a container.

27. The magnetic mounting system of claim 25, wherein the container support comprises a container attachment means.

28. The magnetic mounting system of claim 26, wherein the face for contacting the vertical surface further comprises one or more vertical channels for draining away moisture from the exterior of the nonporous sealed compartment.

29. The magnetic mounting system of claim 27, wherein the container attachment means comprises one or more resilient deformable plugs configured to fit into openings in a container.

30. The magnetic mounting system of claim 29, wherein the face for contacting the vertical surface further comprises one or more vertical channels for draining away moisture from the exterior of the nonporous sealed compartment

31. A magnetic mounting system for wet environments, comprising:
(a) A nonporous sealed compartment enclosing a permanent magnet; said nonporous sealed compartment comprising
(b) a container support; and
(c) a face for contacting a magnetically attracted vertical surface.

32. The magnetic mounting system of claim 31, wherein the container support is formed to be unitary with a container.

33. The magnetic mounting system of claim 31, wherein the container support comprises a container attachment means.

34. The magnetic mounting system of claim 32, wherein the face for contacting a magnetically attracted vertical surface further comprises one or more vertical channels for draining away moisture from the exterior of the nonporous sealed compartment.

35. The magnetic mounting system of claim 33, wherein the container attachment means comprises one or more resilient deformable plugs configured to fit into openings in a container.

36. The magnetic mounting system of claim 35, wherein the face for contacting a magnetically attracted vertical surface further comprises one or more vertical channels for draining away moisture from the exterior of the nonporous sealed compartment.
